(19) United States
(12) Patent Application Publication
(10) Pub. No.: US 2002/0125016 A1
(43) Pub. Date: Sep. 12, 2002

(54) Aerial fire suppression system

(76) Inventor: Phillip Lorenzo Cofield, Clear Water, FL (US)

Correspondence Address: Phillip Lorenzo Cofield, 1716 Evans Drive, Clear Water, FL, 33759, US

(21) Appl. No.: 09/804,278

(22) Filed: Mar. 12, 2001

(51) Int. Cl. B64D 1/16

(52) U.S. Cl. 169/53; 169/51; 169/13

(57) ABSTRACT

An aerial fire suppression system that is used to put out major fires from the air. This invention is usually used in conjunction with a helicopter. This invention uses a constant flow of water to put out a major forest fires. The aerial fire suppression system uses a fire hose 14 to supply the helicopter with a constant flow of water. The other end of the fire hose connects to the hose boom unit 20. The hose boom unit 20 lifts the fire hose above the trees to create an obstruction free path from the helicopter and the water supply. The hose boom unit 20 supply water by connecting to a fire truck, water truck, fire hydrant, lake or any water supply or fire suppression solution. This invention may also be used to clean up oil spills.

### BACKGROUND FIELD OF INVENTION

This invention relates to airborne systems that are used to put out forest fires.

### BACKGROUND DESCRIPTION OF PRIOR ART

In certain airborne fire suppression units of the type known to the art and shown for example in Eveleth U.S. Pat. No. 3,220,482 and Andrews U.S. Pat. No. 3,273,651 fluid tanks and manually controllable nozzle equipment are suspended beneath the aircraft body. Such systems are designed to permit quick installation and removal of the fire fighting equipment, which is a highly desirable objective in view of the many other proposed such as cargo and personnel transportation for which the aircraft must also be utilized. Unfortunately, such suspended units materially alter the aerodynamic characteristics of the aircraft and in addition impede its maneuverability during the fire fighting process where maneuverability is most critical.

In other types of airborne fire suppression units, such as those shown in Stansbury et al., U.S. Pat. No. 3494,423 and Gousetis U.S. Pat. No. 3,442,334, the major components of the fire fighting equipment (the most significant of which for the standpoint of bulk is the fluid reservoir tank) are arranged so as to minimize exterior bulk and attendant reduction in aircraft maneuverability. However by so doing certain sacrifices are made reducing the facility of mounting and demounting of the equipment in the aircraft and limiting the fire fighting versatility and effectiveness of the equipment itself. For example, in Stansbury many connections and couplings must be attended to in the mounting or demounting of the fire fighting unit including the securing of tank support brackets required to provide vertical as well as lateral support for the tanks, bleed air couplings between the tanks and the compressor section of the engine to provide pressure for the system, and servo control connections for effecting powered boom position adjustments during flight. Gousetis is somewhat more compact. Still requires power connections for its three separate pumps and substantial mounting assembly to provide vertical support for the reservoir tank. In addition, the versatility and effectiveness of each system is limited by the fixed vertical angles of the fluid nozzles. Eason U.S. Pat. No. 3,897,829 shows an airborne fire suppression unit with a fluid reservoir tank, pump and boom mounting substantially within the body of an aircraft. This invention has the ability of refilling the reservoir during flight. Eason's invention allows the helicopter to refill the reservoirs by hovering over a lake or stream. It uses a suction conduit to refill the reservoir and then it would fly back to fight the fire. Time is very valuable when it comes to fighting an out of control fire. A considerable amount of time could pass while the helicopter is going back to a lake or stream to refill the on board reservoir. Once the helicopter reaches the lake, another block of time is used not fighting the fire. After refilling the helicopter, the helicopter uses another block of time going back to the fire.

There is a need for an airborne fire suppression system that would eliminate the flight to a water source time; refill time and the flight back to the fire.

### SUMMARY

One aspect of this invention is the ability to continuously fight a fire from the air until the fire is put out. The incessant flow of water from the water supply below enables the helicopter to remain in flight without having to leave to refill a reservoir.

Accordingly, several objects and advantages of the present invention are:

(a) to provide a method of fighting a forest fire from the air without having to leave to refill the reservoir.

(b) To provide a method of fighting the fires of a sizeable building structure from the air without having to refill a reservoir.

(c) To deliver water or chemicals for fighting fires in remote locations where there is not a water supply.

Further objects and advantages will become apparent from a consideration of the ensuing description and drawings.

### DRAWINGS FIGURES

FIG.1 is a front view of a helicopter that could be used to put out a fire from the air.

FIG.2 is a side view of a fire hose support truck.

FIG.3 is a control module for the aerial fire suppression system.

FIG.4 is a fire hose roller.

FIG.5 is a picture of a portable fire hose support.

FIG.6 is a picture of a hose lock safety coil.

### REFERENCE: NUMERALS IN DRAWINGS

10. aerial water dispenser

12. hose safety arm

14. fire hose

16. pulley

18. hose boom

20. hose boom unit

22. water pump

23. water intake valve

30. aerial dispenser control

32. fire hose speed control

34. horizontal spray control

36. forward reverse control

38. safety arm up down switch

40. water on/off switch

42. boom up/down switch

44. fire hose wheel

46. lift ring

48. generator

50. control module

52. portable hose support unit

54. fire hose safety coil

56. coil wire

58. coil fire hose lock

### DETAILED DESCRIPTION OF THE DRAWINGS

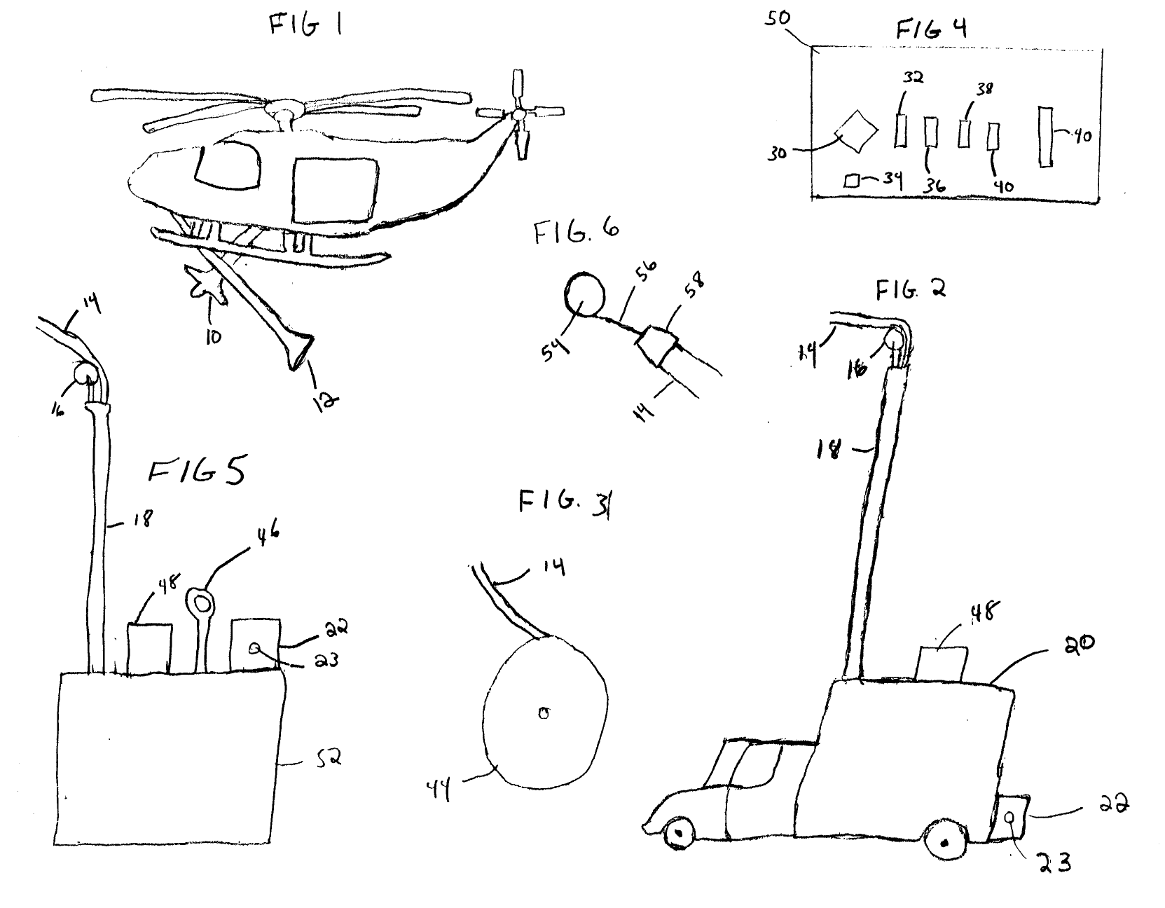

FIG. 1 of the present invention shows a helicopter that has an aerial water dispenser 10 that extends beneath the helicopter. It is connected to the safety hose arm.

FIG. 2 shows a fire hose support truck. A fire hose 14 is connected to the hose safety arm shown in FIG. 1. The fire hose 14 rests on a pulley 16. The pulley 16 is attached to a hose boom 18 or a coil fire hose lock shown in FIG.6. The hose boom 18 is housed in a hose boom unit 20. A water pump 22 is attached to the hose boom unit 20. The water pump 22 has a water intake valve 23. The generator 48 is used to power the water pump 22. This will supply the power to allow the water pump 22 to continue to run when the motor of the hose boom unit 20 is off.

FIG. 3 shows a fire hose wheel 44. The fire hose 14 wraps around the fire hose wheel 44. The fire hose wheel sits inside the hose boom unit 20.

FIG. 4 shows a control module 50. The following modules are displayed on the control module; an aerial dispenser control 30, a fire hose speed control 32, a horizontal spray control 34, a forward/reverse control 36, a safety arm up/down switch 38, and a water on/off switch 40.

FIG. 6 shows a fire hose safety coil 54. The fire hose safety coil 54 is mounted on the helicopter. A coil wire 56 is wrapped around the fire hose safety coil 54. The coil wire 56 goes through the hose safety arm 12. The opposite end of the coil wire 56 is attached to the coil fire hose lock 58. The fire hose lock 58 is attached to the fire hose 14.

### ALTERNATIVE EMBODIMENTS

FIG. 5 shows a portable fire hose support unit 52. The fire hose 14 rests on the pulley 16. The pulley 16 is attached to a hose boom 18. The hose boom 18 is housed in the portable fire hose support unit 52. The water pump 22 is attached to the hose boom unit 20. The water intake valve 23 is positioned on the water pump 22. A generator 48 rests on the portable fire hose support unit 52. A lift ring 46 is connected to the portable fire hose support unit 52.

FIG.6 shows a fire hose safety coil 54. The fire hose safety coil can be adapted to be a safety mechanism when an aircraft is used to pull are tow an object. The aircraft can pull or tow the object. If the modified hose safety coil uncoils, alarms would sound off to let the operator know the aircraft has reached its maximum capacity. This would be especially useful on the helicopter. The modified hose safety coil 54 would uncoil at a predetermined resistance.

### OPERATIONS

FIG. 1 of this invention allows you to put out forest fires by spraying water through the aerial water dispenser 10. The aerial water dispenser 10 may spray water in a narrow area or it may spray water in a wide area. The hose safety arm 12 contracts and extends into and away from the helicopter. The hose safety arm 12 is also used as a safety device. The hose safety arm 14 is used to keep the fire hose 14 away from the helicopter propellers. The hose safety arm 12 is made out of a solid material that would keep the fire hose 14 a safe distance away from the helicopter propeller in the event of an emergency maneuver. The hose safety arm 12 is used to connect the fire hose 14 to the aerial water dispenser10. The hose safety arm 12 is used to pull the hose 14 from around the fire hose wheel 44.

FIG. 2 of this invention shows the pulley 16 is used to reduce the friction while the helicopter is pulling the fire hose 14. The pulley 16 is attached at the top of the hose boom 18. The fire hose 14 will come out of the hose boom 18. The hose boom 18 is used to raise the fire hose 14 above the trees, power lines, and anything that would obstruct the path of the hose from the helicopter to the hose boom unit 20. The hose boom unit 20 is placed on a truck body that is used in conjunction with the helicopter to put out major fires. The hose boom unit 20 transports the fire hose 14, the pulley 16, the hose boom 18, the water pump 22, the water intake valve 23, and the fire hose wheel 44. The water pump 22 is used to extract water from the water intake valve 23. The water will come from a fire hydrant, a fire truck, a lake, a river or any other water source and pump it through the fire hose 14.

FIG. 3 of the present invention shows the hose roller 44. The hose roller is placed inside the hose boom unit 20. The hose roller 44 is controlled remotely and locally. The hose roller is used to roll and unroll the fire hose 14.

FIG. 4 of the present invention shows the control module 50. The control module 50 has the water dispenser control 30. The aerial dispenser control 30 is used to control the aerial water dispenser 10. The aerial dispenser control 30 is used to move the aerial water dispenser up, down right and left. This will change the direction of the water flow. The fire hose speed control 32 controls the fire hose wheel 44 speed. The fire hose speed control 32 makes the fire hose wheel 44 move from stop to fast motion. The horizontal spray control 34 controls the flow of water from the aerial water dispenser 10. The horizontal spray control 34 allows the aerial water dispenser to spray horizontally to cover a wide area or directionally to force water into a more specific area. The forward reverse control 36 controls the direction of the fire hose wheel 44. The safety arm up/down switch 38 moves the hose safety arm 12 from the up position to a down position. The water on and off switch 40 turns the flow of water coming out of the aerial water dispenser 10 on and off. The boom up and down switch 18 raises and lowers the hose boom 18. The fire hose 14 needs to be on the ground when the helicopter is on the ground. This is done by lowering the hose boom 18 all the way down. The fire hose 14 would then be pulled from the hose boom 18. Their should be enough fire hose 14 pulled out of the boom to allow the hose boom unit and the fire hose 14 to be a safe distance away from the helicopter propellers. The hose boom 18 is lowered and raised by moving the hose boom up down switch 42.

FIG. 5 shows a portable hose support unit 52. The portable hose support unit 52 has most of the feature of hose boom unit 20. The portable hose support unit 52 is not built on a truck base as the hose boom unit 20. The portable hose support unit 52 can be transported by helicopter to a remote location where a truck cannot go. The lift ring 46 is used to lift the portable hose support unit 52.

FIG.6 shows an additional safety feature. The fire hose 14 is designed to uncoil from the fire hose wheel 44. The helicopter will pull the fire hose 14 while it is in flight. The fire hose safety coil 54 is used as a safety mechanism for the helicopter. The fire hose safety coil 54 is designed to uncoil in the event the fire hose 14 is caught on something or the fire hose wheel 44 is stuck or locked up. If the fire hose safety coil safety coil 54 uncoils. It will sound an alarm that will trigger an alarm on the ground that will automatically shut off the flow of water. The fire hose safety coil is an additional safety mechanism for a pilot or copilot that is not paying attention to the slack that that is in the fire hose 1. This could prevent the helicopter from crashing. Once the situation is corrected, the pilot or support member that is riding onboard the helicopter can reset the system and proceed with the task of fighting fires.

### CONCLUSION, RAMIFICATIONS AND SCOPE

Thus, the reader will see that the aerial fire suppression system would be very effective and efficient when it comes to combating major forest fires. The helicopter with the reservoir has been a major weapon in fighting major fires in the past because a helicopter can get into places people, fire trucks and other fire fighting equipment cannot go. Even though the helicopters has aided in the fighting of major fires in the past, they are very limited and inefficient. They are limited to the amount of water they can drop on the fire before they have to leave to refill their reservoirs. The helicopter with the reservoir would spend a large amount of time flying away from the fire, refilling the reservoir, and back to the fire before it can fight the fire again. The aerial fire suppression system is very effective and very efficient. The aerial fire suppression system allows the fire fighter to fight the fire from the air. The fire fighter using this system would not have to leave the fire to refill a reservoir because there will be a constant flow of water. The ground crew would make sure the water supply is constant. They could do this by connecting to the fire hose to a fire hydrant, a lake, fire truck or another water source. The ground crew could connect the hose to two trucks simultaneously. When one of the trucks gets low, they would open the valve for the other truck. The empty truck would leave to refill its'tank, while the aerial fire suppression system remains in operation to fight the fire. After the empty truck is refilled, it would return to reconnect to the aerial fire suppression system. This cycle could continue until there is a need to stop.

While the above descriptions contain much specificity, these should not be construed as limitations on the scope of the invention, but rather as an exemplification of one preferred embodiment thereof. Many other variations are possible. For example, the aerial fire suppression system may be used to spray chemical on a fire instead of water. The aerial fire suppression system may be used to fight a high-rise building fire. The fire hose safety coil 54 may be modified to pull a power line or pull cargo instead of the fire hose 14. If the coil meets a predetermined resistance the coil that is onboard, the helicopter would uncoil and release some line and send off alarms to alert the pilot of the danger. This invention may be used to spray water or fertilizer on plants or trees.

This invention may be modified to clean up oil spills by spraying chemicals that would combat the oil spill on the spill or reversing the water flow process. This could be done by modifying the aerial water dispenser 10. The aerial water dispenser 10 would be extended and instead to the point were it would touch the water and instead of expelling water, it would intake water and oil. The water would then go through the hose and into a tank for processing. The helicopter cleaning up the oil spill may not need a boom to raise the hose because there wouldn't be many things to obstruct connection from the hose to the helicopter. The use of the helicopter would be more advantages than a ship because; the helicopter is faster and can go directly to the spot of accumulation. Using the helicopter will increase the visibility because it is easier to see an oil spill from the air than being on a ship at the same level of the spill.

This invention will help save the forest by putting out fires quicker. It will also help save the sea life and our beaches by rapidly cleaning up oil spills.

I claim

1. A means for allowing a object to remain connected to an airborne aircraft that is in motion from a device that is not airborne whereby allowing the aircraft to fight a fire by spraying water onto the fire without leaving to refill said reservoir or clean up oil spills by spraying chemicals on the spill or pumping the contaminated oil and water into a container for processing.

2. The object of claim 1 wherein said object is a hose.

3. The object of claim 1 wherein said object is a line.

4. The aircraft of claim 1 wherein said aircraft is said helicopter.

5. The aircraft of claim 1 wherein said aircraft is an airplane.

6. The connection to said aircraft of claim 1 wherein said connection comprising of
a boom for raising the hose whereby allowing the hose to be free from obstruction.

7. The hose of claim 1 wherein said hose is a fire hose

8. A safety device that is onboard an aircraft that will uncoil when said aircraft receives a predetermined resistance from the object it is pulling or lifting whereby allowing the aircraft to become more versatile which will allow the aircraft to pull or lift heavier, unstable objects without meeting an unexpected force so great that it could cause the aircraft to crash.

9. The object of claim 8 wherein said object is a hose.

10. The object of claim 1 wherein said object is a line.

11. A device that is used to control a machine that is not airborne and not on said aircraft with a means of allowing water or chemicals to continuously flow to or from said aircraft whereby allowing the aircraft to control said hose boom unit 14 from said aircraft.
